(19) United States
(12) Patent Application Publication
(10) Pub. No.: US 2025/0141016 A1
(43) Pub. Date: May 1, 2025

(54) FLOOR STRUCTURE FOR AN ELECTRIC-POWERED MOTOR VEHICLE

(71) Applicant: TREVES PRODUCTS, SERVICES & INNOVATION, Paris (FR)

(72) Inventors: Francois CHOQUART, Paris (FR); Eric DELINSELLE, Paris (FR); Guillaume CRIGNON, Paris (FR)

(21) Appl. No.: 18/835,739

(22) PCT Filed: Feb. 3, 2023
(86) PCT No.: PCT/EP2023/052727

§ 371 Date: Aug. 5, 2024

(30) Foreign Application Priority Data
Feb. 7, 2022 (FR) 2201040

(51) Int. Cl. H01M 50/249; B32B 5/26; B60L 50/60; B60R 13/08; B62D 25/20; H01M 10/625; H01M 10/658

(52) U.S. Cl. CPC H01M 50/249; B32B 5/26; B60R 13/083; H01M 10/625; H01M 10/658; B32B 2262/0253; B32B 2262/0284; B32B 2307/102; B32B 2307/304; B32B 2307/54; B32B 2605/00; B60L 50/66; B62D 25/20; H01M 2220/20

(57) ABSTRACT

The invention relates to a floor structure (1) for an electric-powered motor vehicle successively comprising, from bottom to top: a battery (2) arranged in a tray (3), a floor plate (5) facing said battery and an acoustic trim lining (6) arranged on said plate, said structure further comprising a fibrous and porous thermal protection layer (7) arranged between said lining and said plate, said protection layer comprising thermal protection fibers based on at least one fusible material and structural fibers of one or more types, said fibers being infusible or based on material having a melting point greater than the maximum melting point of said protection fibers.

The invention relates to a floor structure for electric-powered motor vehicles, and to a method for implementing thermal protection for an acoustical trim lining included in such a structure.

It is known to produce a floor structure for an electric-powered motor vehicle successively comprising, from bottom to top:
a battery arranged in a tray,
a floor plate facing said battery,
an acoustical trim lining on said plate.

However, which such an arrangement, in the event of battery overheating—in particular as a result of thermal runaway caused by a short-circuit, a vehicle impact with a foreign element intruding into the battery, etc.—there is a risk of excessive heat spreading to the plate and the lining, and the latter could ignite and/or emit toxic smoke.

For ensuring thermal protection of the lining by the addition of a thermal protection means, a number of constraints must be taken into account:
do not encroach, or only moderately encroach, on the interior volume of the vehicle,
do not impair, or only moderately impair, the load-bearing capacity of the lining fitted with the protection means,
do not impair, or only moderately impair, the acoustic protection provided by the lining.

The aim of the invention is to propose an structure that allows to protect the lining while taking into account the above-mentioned constraints.

To this end, and according to a first aspect, the invention proposes a floor structure for an electric-powered motor vehicle successively comprising, from bottom to top:
a battery arranged in a tray,
a floor plate facing said battery,
an acoustical trim lining arranged on said plate,
   said structure further comprising a fibrous and porous thermal protection layer arranged between said lining and said plate, said protection layer comprising:
thermal protection fibers based on at least one fusible material,
and structural fibers of one or more types, said fibers being infusible or based on a material with a melting point greater than the maximum melting point of said protection fibers.

The reference to the maximum melting point of the protection fibers is used to take into account the case where the protection fibers have two melting points—such as the two-component fibers explained later—or the case of a mixture of protection fibers with different melting points.

With the proposed arrangement, a thermal protection layer underneath the lining allows to protect it from overheating, thus by melting the thermal protection fibers.

Indeed, fusion corresponds to an endothermic phase change; consequently, part of the heat released by the battery is devoted to fusion of the protection fibers, thereby limiting the amount of heat transmitted to the lining.

Moreover, provided that the protection fibers are chosen with care—in particular by an appropriate choice of their chemical nature, their thermal mass capacity, their diameter, etc.—thermal protection can be reconciled with the below-mentioned constraints:
the impact of the addition of the protection layer on the interior volume available in the vehicle is limited by using a thin protection layer, while the thickness of the lining can be reduced to provide space for receiving the layer,
sufficient load-bearing capacity is maintained for the stack formed by the lining and the protection layer, thus allowing to prevent excessive sinking of the assembly under the weight of a passenger or object,
acoustic protection is preserved; indeed, the fibrous and porous nature of the protection layer gives it sound-absorbing properties in addition to those provided by the lining.

According to a second aspect, the invention proposes a method for implementing thermal protection for an acoustical and trim lining included in such an structure.

Further features and advantages of the invention will become apparent from the following description, made with reference to the attached figures, in which:

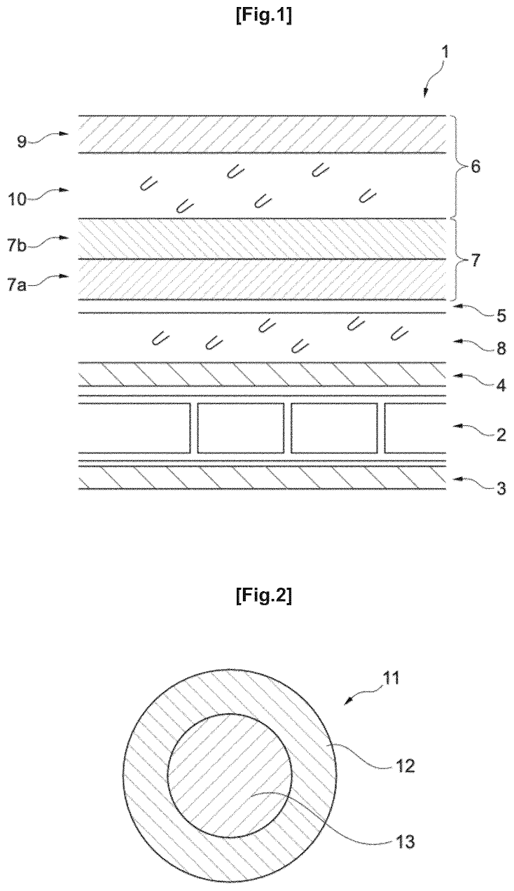

FIG. 1 is a schematic partial cross-sectional representation of a structure according to one embodiment,

FIG. 2 is a schematic cross-sectional representation of a bi-component fiber.

With reference to the figures, we describe a floor structure 1 for an electric-powered motor vehicle successively comprising, from bottom to top:
a battery 2 arranged in a tray 3, said tray being notably provided with a lid 4 in the embodiment shown,
a floor plate 5—in particular for the passenger compartment and/or luggage compartment—facing said battery,
an acoustical trim lining 6 arranged on said plate,
   said structure further comprising a fibrous and porous thermal protection layer 7 arranged between said lining and said plate, said protection layer comprising:
thermal protection fibers based on at least one fusible material—infusible additives may also be present (talcum filler, etc.),
and structural fibers of one or more types—e.g. glass fibers or natural fibers—, said fibers being infusible or based on a material having a melting point greater than the maximum melting point of said protection fibers.

According to various embodiments, the floor plate 5 faces the cover 4 with the interposition, according to the embodiment shown, of an elastically compressible decoupling intermediate layer 8—for example foam-based—or an air gap, according to an embodiment not shown.

For example, in the embodiment shown, the lining 6 may comprise a layer of covering material 9—such as a carpet—and an elastically compressible decoupling layer 10—in particular based on foam and/or fibers.

According to one embodiment, the protection fibers are, at least in part, of the mono-component type, said fibers being based on a single fusible material, for example polypropylene, polyamide or polyethylene terephthalate.

According to an embodiment illustrated in FIG. 2, the protection fibers are, at least in part, of the bi-component type 11, said fibers comprising a sheath 12 based on a first fusible material and a core 13 based on a second fusible material, the melting point of said first material being lower than that of said second material, said sheath ensuring, following its melting—for example following thermocompression—the bond between the fibers of the protection layer 7.

With such an arrangement, it is possible to observe melting of the sheath 12 only in the event of a moderate temperature rise, or successively of said sheath and then of the core 13 in the event of a greater temperature rise.

According to various embodiments, the core 13 is based on polyethylene terephthalate and the sheath 12 is based on modified polyethylene terephthalate or polyethylene.

In one embodiment, the protection layer 7 comprises at least two types of protection fibers fusible at different temperatures, so as to enable stepwise melting of said layer.

With such an embodiment, if the temperature is not too high, the most temperature-resistant fibers remain intact and thus contribute, along with the structural fibers, to the structure of the protection layer 7.

According to one embodiment, the resistance to air passage of the protection layer 7 is less than 6000 N.s.m⁻³, being for example between 3000 and 4000 N.s.m⁻³, which allows to ensure sound absorption and limits the negative influence of a high Young's modulus on acoustic protection performance.

In one embodiment, the Young's modulus in compression of the protection layer 7 is greater than 35 MPa, which allows to ensure satisfactory load-bearing capacity.

According to one embodiment, the thermal conductivity of the protection layer 7 between −40 and +45° C. is between 0.03 and 0.12 W.m⁻¹.K⁻¹

According to an embodiment not shown, the protection layer 7 is single-layered, 15 the protection fibers—whether of one or more types—and structural fibers being mixed together.

As shown in FIG. 1, the protection layer 7 comprises a plurality of sub-layers 7a, 7b, each comprising protection fibers mixed with structural fibers.

In an embodiment not shown, the structure 1 also includes a layer of thermal insulation, for example based of cork, arranged between the floor plate 5 and the protection layer 7, thereby enhancing thermal protection.

In one embodiment, the protection layer 7 has a thickness of between 4 and 8 mm.

In one embodiment, the protection layer 7 is needle-punched.

In one embodiment, the protection layer 7 has undergone a hot compression operation, with certain zones—such as “foot cellars”—being over-compressed to increase their load-bearing capacity.

According to one embodiment, the percentage by mass of protection fibers is between 60 and 90% by mass of the protection layer 7.

Finally, a method is described for implementing thermal protection for an acoustical trim lining 6 included in the structure 1, said lining being intended to be arranged on a floor plate 5 of said vehicle, said method providing for arranging, between said plate and said lining, a fibrous and porous thermal protection layer 7 comprising:
thermal protection fibers based on at least one fusible material,
and structural fibers of one or more types, said fibers being infusible or based on a material having a melting point greater than the maximum melting point of said protection fibers.

1. Floor structure (1) for an electric-powered motor vehicle successively comprising, from bottom to top:
a battery (2) arranged in a tray (3),
a floor plate (5) facing said battery,
an acoustical trim lining (6) arranged on said plate,
said structure being characterized in that it further comprises a fibrous and porous thermal protection layer (7) arranged between said lining and said plate, said protection layer comprising:
thermal protection fibers based on at least one fusible material, and structural fibers of one or more types, said fibers being infusible or based on a material having a melting point greater than the maximum melting point of said protection fibers.

2. Structure according to claim 1, characterized in that the protection fibers are, at least in part, of the mono-component type, said fibers being based on a single fusible material.

3. Structure according to claim 1, characterized in that the protection fibers are, at least in part, of the bi-component type (11), said fibers comprising a sheath (12) based on a first fusible material and a core (13) based on a second fusible material, the melting point of said first material being lower than that of said second material, said sheath ensuring, following its melting, the bond between the fibers of the protection layer (7).

4. Structure according to claim 1, characterized in that the protection layer (7) comprises at least two types of protection fibers fusible at different temperatures, so as to enable stepwise melting of said layer.

5. Structure according to claim 1, characterized in that the resistance to the passage of air of the protection layer (7) is less than 6000 N.s.m⁻³.

6. Structure according to claim 1, characterized in that the Young's modulus in compression of the protection layer (7) is greater than 35 MPa.

7. Structure according to claim 1, characterized in that the thermal conductivity of the protection layer (7) between −40 and +45° C. is between 0.03 and 0.12 W.m⁻¹.K⁻¹.

8. Structure according to claim 1, characterized in that the protection layer (7) is single-layered, the protection fibers and the structural fibers being mixed together.

9. Structure according to claim 1, characterized in that the protection layer (7) comprises a plurality of sub-layers (7a, 7b) each comprising protection fibers mixed with structural fibers.

10. A method for implementing thermal protecting for an acoustic trim lining (6) included in a structure (1) according to claim 1, said lining being intended to be arranged on a floor plate (5) of said vehicle, said method providing for arranging, between said plate and said lining, a fibrous and porous thermal protection layer (7) comprising:
thermal protection fibers based on at least one fusible material,
and structural fibers of one or more types, said fibers being infusible or based on a material having a melting point greater than the maximum melting point of said protection fibers.
